(19) United States
(12) Patent Application Publication
(10) Pub. No.: US 2022/0003875 A1
(43) Pub. Date: Jan. 6, 2022

(54) DISTANCE MEASUREMENT IMAGING SYSTEM, DISTANCE MEASUREMENT IMAGING METHOD, AND NON-TRANSITORY COMPUTER READABLE STORAGE MEDIUM

(71) Applicant: Panasonic Intellectual Property Management Co., Ltd., Osaka (JP)

(72) Inventors: Manabu USUDA, Hyogo (JP); Shinzo KOYAMA, Osaka (JP); Akihiro ODAGAWA, Osaka (JP)

(21) Appl. No.: 17/480,458

(22) Filed: Sep. 21, 2021

Related U.S. Application Data
(63) Continuation of application No. PCT/JP2020/010092, filed on Mar. 9, 2020.

(30) Foreign Application Priority Data
Mar. 26, 2019 (JP) 2019-059472

(51) Int. Cl. G01S 17/894; G01S 17/10

(52) U.S. Cl. CPC G01S 17/894; G01S 17/10

(57) ABSTRACT

A distance measurement imaging system includes a first acquisition unit that acquires first 2D data from an imaging unit, a second acquisition unit that acquires first 3D data from a distance measurement unit, a third acquisition unit that acquires second 2D data and second 3D data from a detection unit, and a computation unit. The imaging unit acquires a first 2D image of a target space. The distance measurement unit acquires a first 3D image of the target space. The detection unit acquires a second 2D image and a second 3D image of the target space with a coaxial optical system. The computation unit executes a processing for making an association between the first 2D data and the second 2D data and a processing for making an association between the first 3D data and the second 3D data.

### CROSS-REFERENCE TO RELATED APPLICATIONS

The present application is a Bypass continuation of International Application No. PCT/JP2020/010092, filed on Mar. 9, 2020, which is based upon and claims the benefit of priority to Japanese Patent Application No. 2019-059472, filed on Mar. 26, 2019, the entire contents of both applications are incorporated herein by reference.

### TECHNICAL FIELD

The present disclosure relates to distance measurement imaging systems, distance measurement imaging methods, and non-transitory computer readable storage mediums, and more particularly to a distance measurement imaging system, a distance measurement imaging method, and a non-transitory computer readable storage medium that stores a program for acquiring luminance information and distance information of a target space.

### BACKGROUND ART

JP2005-77385A discloses an image correlation method.

In this image correlation method, 3D point group data of a measurement object is acquired by a laser scanner, and a 2D color image is acquired by capturing the measurement object. Then, three or more points are selected arbitrarily on the 2D color image, and 3D position information is given to each of the selected points based on the 3D point group data. A relative position relation between a camera and the laser scanner at the capturing time of the measurement object is then calculated based on the 3D position information on the selected points. Image data of the color image is correlated with data on each point contained in the point group data, based on the calculated relative position relation and the 3D position information on the selected points.

### SUMMARY

In a case where a camera and a laser scanner are individually disposed, it is difficult to make an association between an image (luminance information) captured by the camera and data (distance information) acquired by the laser scanner, since these devices are different in capturing/acquisition timings of data, observing points, data formats and the like.

The present disclosure is aimed to propose a distance measurement imaging system, a distance measurement imaging method, and a non-transitory computer readable storage medium that stores a program, capable of acquiring data associating luminance information and distance information with each other.

A distance measurement imaging system of one aspect of the present disclosure includes a first acquisition unit, a second acquisition unit, a third acquisition unit, and a computation unit. The first acquisition unit is configured to acquire first two-dimensional (2D) data from an imaging unit that acquires a first 2D image of a target space. The second acquisition unit is configured to acquire first three-dimensional (3D) data from a distance measurement unit that acquires a first 3D image of the target space. The third acquisition unit is configured to acquires second 2D data and second 3D data from a detection unit that acquires a second 2D image and a second 3D image of the target space with a coaxial optical system. The computation unit is configured to execute a processing for making an association between the first 2D data and the second 2D data and a processing for making an association between the first 3D data and the second 3D data.

A distance measurement imaging method of one aspect of the present disclosure includes a first acquisition step, a second acquisition step, a third acquisition step, and a processing step. The first acquisition step includes acquiring first 2D data from an imaging unit that acquires a first 2D image of a target space. The second acquisition step includes acquiring first 3D data from a distance measurement unit that acquires a first 3D image of the target space. The third acquisition step includes acquiring second 2D data and second 3D data from a detection unit that acquires a second 2D image and a second 3D image of the target space with a coaxial optical system. The processing step includes executing a processing for making an association between the first 2D data and the second 2D data and a processing for making an associate on between the first 3D data and the second 3D data.

A distance measurement imaging system of one aspect of the present disclosure includes a first acquisition unit, a second acquisition unit, and a computation unit. The first acquisition unit is configured to acquire first 2D data. The second acquisition unit is configured to acquire second 2D data and first 3D data with a coaxial optical system. The computation unit is configured to execute a processing for making an association between the first 2D data and the second 2D data and a processing for making an association between the first 2D data and the first 3D data.

A distance measurement imaging method of one aspect of the present disclosure includes a first acquisition step, a second acquisition step, and a processing step. The first acquisition step includes acquiring first 2D data. The second acquisition step includes acquiring second 2D data and first 3D data with a coaxial optical system. The processing step includes executing a processing for making an association between the first 2D data and the second 2D data and a processing for making an association between the first 2D data and the first 3D data.

A program of one aspect of the present disclosure is a program configured to cause one or more processors to execute the distance measurement imaging method. A non-transitory computer readable storage medium of one aspect of the present disclosure stores the program configured to cause one or more processors to execute the distance measurement imaging method.

### BRIEF DESCRIPTION OF DRAWINGS

The figures depict one or more implementation in accordance with the present teaching, by way of example only, not by way of limitations. In the figures, like reference numerals refer to the same or similar elements, where:

FIG. 1 is a block diagram illustrating a distance measurement imaging system of an embodiment;

FIG. 2 is a block diagram illustrating an imaging unit of the distance measurement imaging system of the embodiment;

FIG. 3 is a block diagram illustrating a distance measurement unit of the distance measurement imaging system of the embodiment;

FIG. 4 is a block diagram illustrating a detection unit of the distance measurement imaging system of the embodiment;

FIG. 5 is an illustrative view illustrating an operation of the distance measurement unit of the embodiment;

FIG. 6 is a block diagram illustrating a signal processing unit of the distance measurement imaging system of the embodiment;

FIG. 7A is an illustrative view illustrating an example of a first luminance image acquired by the imaging unit of the embodiment;

FIG. 7B is an enlarged view of A1 part in FIG. 7A;

FIG. 8A is an illustrative view illustrating an example of a first distance image acquired by the distance measurement unit of the embodiment;

FIG. 8B is an enlarged view of A2 part in FIG. 8A;

FIG. 9A is an illustrative view illustrating an example of a second luminance image acquired by the detection unit of the embodiment;

FIG. 9B is an enlarged view of A3 part in FIG. 9A;

FIG. 10A is an illustrative view illustrating an example of a second distance image acquired by the detection unit of the embodiment;

FIG. 10B is an enlarged view of A4 part in FIG. 10A;

FIG. 11 is a block diagram illustrating a distance measurement imaging system of a first variation; and

FIG. 12 is an illustrative view illustrating a procedure for generating integration data of the distance measurement imaging system of the first variation.

### DETAILED DESCRIPTION

A distance measurement imaging system 1 of an embodiment of the present disclosure will be explained with reference to drawings. However, the embodiment described below is mere an example of various embodiments of the present disclosure. The below described embodiment may be modified in various ways in accordance with design or the like as long as the object of the present disclosure can be achieved.

### (1) Embodiment

(1.1) Overview

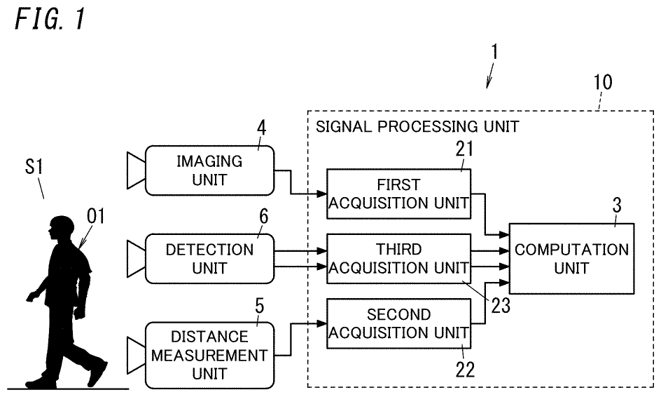

As shown in FIG. 1, a distance measurement imaging system 1 of the present embodiment includes a first acquisition unit 21, a second acquisition unit 22, a third acquisition unit 23, and a computation unit 3.

The first acquisition unit 21 includes a communications interface. The first acquisition unit 21 is connected to the computation unit 3. The first acquisition unit 21 is configured to be connected to an imaging unit 4. The first acquisition unit 21 is configured to acquire first 2D data from the imaging unit 4. The first 2D data includes information about a first 2D image of the target space S 1, for example. The first 2D image is acquired by the imaging unit 4. The first acquisition unit 21 acquires, from the imaging unit 4, the first 2D data relating to the first 2D image of the target space S1, for example.

The second acquisition unit 22 includes a communications interface. Thee second acquisition unit 22 is connected to the computation unit 3. The second acquisition unit 22 is configured to be connected to the distance measurement unit 5. The second acquisition unit 22 is configured to acquire first 3D data from the distance measurement unit 5. The first 3D data includes information about a first 3D image of the target space S1, for example. The first 3D image is acquired by the distance measurement unit 5. The first 3D image is an image indicative of a distance to an object O1 present in the target space S1. The second acquisition unit 22 acquires, from the distance measurement unit 5, the first 3D data relating to the first 3D image of the target space S1, for example.

The third acquisition unit 23 includes a communications interface. The third acquisition unit 23 is connected to the computation unit 3. The third acquisition unit 23 is configured to be connected to a detection unit 6. The third acquisition unit 23 is configured to acquire second 2D data and second 3D data from the detection unit 6. The second 2D data includes information about a second 2D image of the target space S1, for example. The second 2D image is acquired by the detection unit 6. The second 3D data includes information about a second 3D image of the target space S1, for example. The second 3D image is acquired by the detection unit 6. The second 3D image is an image indicative of a distance to the object O1 present in the target space S1, for example. The detection unit 6 is configured to acquire the second 2D image and the second 3D image with a coaxial optical system. The third acquisition unit 23 acquires, from the detection unit 6, the second 2D data relating to the second 2D image of the target space S1 and the second 3D data relating to the second 3D image of the target space S1, for example.

The computation unit 3 is configured to execute a processing for making an association between the first 2D data and the second 2D data and a processing for making an association between the first 3D data and the second 3D data.

According to the distance measurement imaging system 1 of the present embodiment, the computation unit 3 makes an association between the first 2D data and the second 2D data and makes an association between the first 3D data and the second 3D data. As a result, the first 2D data and the first 3D data are associated with each other through the second 2D data and the second 3D data acquired by the detection unit 6. It is therefore possible to acquire data associating 2D data (the first 2D image) and 3D data (the first 3D image) with each other.

### (2) Configurations

The distance measurement imaging system 1 of the present embodiment is explained in further detail with reference to FIG. 1 to FIG. 10B. In the embodiment, the distance measurement imaging system 1 is assumed to be installed on a vehicle such as an automobile to serve as an object detection system for detecting an obstacle. However, the distance measurement imaging system 1 is not limited to be used thereto. The distance measurement imaging system 1 may be used for a surveillance camera or security camera to detect an object (person), for example.

As shown in FIG. 1, the distance measurement imaging system 1 of the present embodiment includes a signal processing unit 10, the imaging unit 4, the distance measurement unit 5, and the detection unit 6. The signal processing unit 10 includes the first acquisition unit 21 to the third acquisition unit 23, and the computation unit 3. In the embodiment, the imaging unit 4, the distance measurement unit 5, and the detection unit 6 have mutually different light receiving units and optical systems, and have mutually different optical axes. However, the imaging unit 4, the distance measurement unit 5, and the detection unit 6 are disposed such that the optical axes thereof are almost aligned with each other, and receive light from the same target space S1.

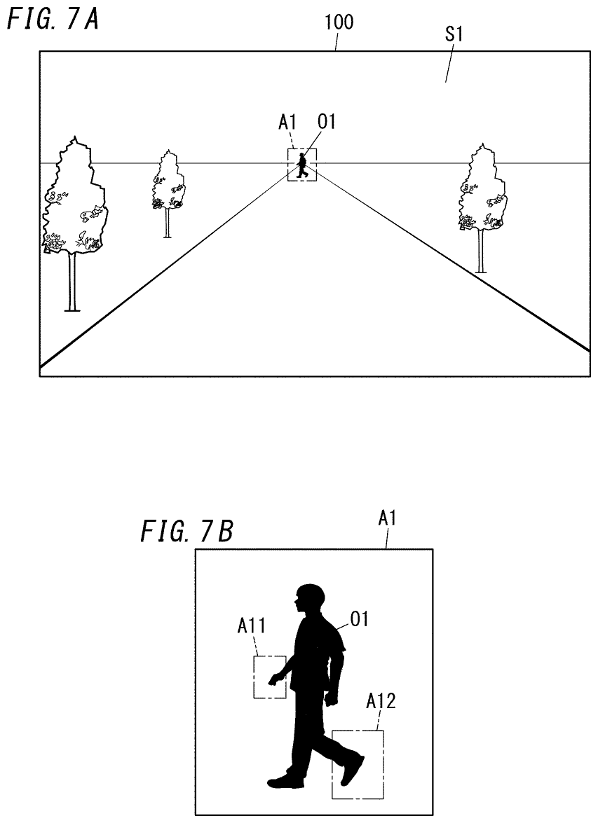

The imaging unit 4 is configured to acquire the first 2D image of the target space S1. In the embodiment, the imaging unit 4 captures an image of the target space S1 to acquire a first luminance image 100 (see FIG. 7A) as the first 2D image. The imaging unit 4 includes a solid-state imaging device such as a Charge Coupled Devices (CCD) image sensor or a Complementary Metal-Oxide Semiconductor (CMOS) image sensor, for example. The imaging unit 4 receives an external light. The external light may include a radiation light radiated from a luminous object (the sun, a luminaire, and the like), a scattered light that the radiation light is scattered by an object O1, and the like.

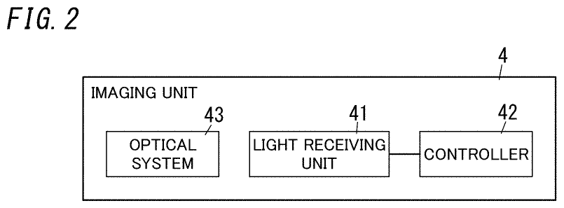

As shown in FIG. 2, the imaging unit 4 includes a light receiving unit (hereinafter, also referred to as “first light receiving unit”) 41, a controller (hereinafter, also referred to as “first controller 42”), and an optical system (hereinafter, also referred to as “first optical system”) 43.

The first light receiving unit 41 includes a plurality of pixel cells arranged in a 2D array. Each of the plurality of pixel cells includes a light receiving device such as a photodiode. The light receiving device includes a photoelectric converter that converts a photon into an electric charge. Each of the plurality of pixel cells receives the light only while it is exposed. The exposure timings of the pixel cells are controlled by the first controller 42. Each of the plurality of pixel cells outputs an electric signal indicative of the light received by the light receiving device. The signal level of the electric signal corresponds to the amount of light received by the light receiving device.

The first optical system 43 includes a lens that focuses the external light on the first light receiving unit 41, for example. The first optical system 43 may include a color filter for selecting the wavelength of light to be incident on the pixel cell.

The first controller 42 may be implemented by a computer system including one or more memories and one or more processors. The functions of the first controller 42 is realized by the one or more processors of the computer system executing a program stored in the one or more memories. The program may be stored in advance in the memory, or may be provided through a telecommunications network such as the Internet, or may be provided through a non-transitory storage medium such as a memory card.

The first controller 42 is configured to control the first light receiving unit 41. The first controller 42 generates the first luminance image 100, which is a 2D image, based on the electric signals provided from the pixel cells of the first light receiving unit 41. The first controller 42 generates first 2D data, and outputs the generated first 2D data to the signal processing unit 10. The first 2D data includes first luminance information indicative of the generated first luminance image 100. The first controller 42 outputs, as the first 2D data, the first luminance information to the signal processing unit 10 (the first acquisition unit 21).

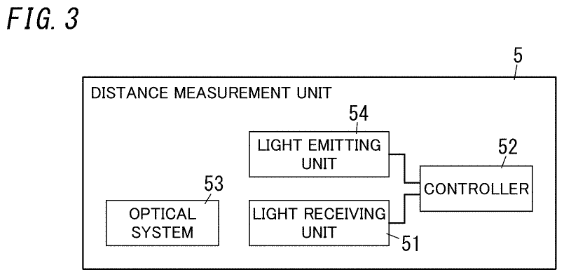

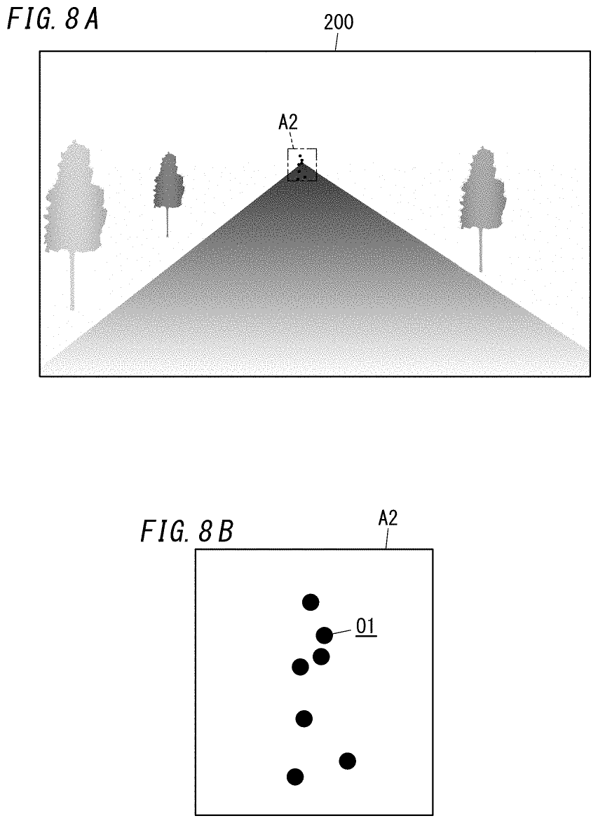

The distance measurement unit 5 is configured to acquire the first 3D image of the target space S1. In the embodiment, the first 3D image is a first distance image 200. In the embodiment, the distance measurement unit 5 measures a distance to the object O1 based on the Time Of Flight (TOF) method to acquire the first distance image 200 (see FIG. 8A). As shown in FIG. 3, the distance measurement unit 5 includes a light receiving unit (hereinafter, also referred to as “second light receiving unit”) 51, a controller (hereinafter, also referred to as “second controller”) 52, an optical system (hereinafter, also referred to as “second optical system”) 53, and a light emitting unit (hereinafter, also referred to as “first light emitting unit”) 54.

The distance measurement unit 5 in the example described hereinafter uses the TOF method, but is not limited thereto. For example, the distance measurement unit 5 may uses the LiDAR method of emitting a pulsed light of laser and detecting a reflected light from an object to determine a distance based on a reflection time.

The first light emitting unit 54 includes a first light source that emits a pulsed light. The light emitted from the first light emitting unit 54 may be monochromatic, with a relatively short pulse width, and a relatively high peak intensity. The wavelength of the light emitted from the first light emitting unit 54 may be within the wavelength range of the near infrared band where the human visible sensitivity is low and insusceptible to the disturbance light from sunlight. In the present embodiment, the first light emitting unit 54 includes a laser diode and emits a pulsed laser, for example. The emission timing, the pulse width, the emission direction and the like of the first light emitting unit 54 are controlled by the second controller 52.

The second light receiving unit 51 includes a solid-state imaging device. The second light receiving unit 51 receives a reflected light, which is the light emitted from the first light emitting unit 54 and reflected by an object O1. The second light receiving unit 51 includes a plurality of pixel cells arranged in a 2D array. Each of the plurality of pixel cells includes a light receiving device such as a photodiode. The light receiving device may be an avalanche photodiode. Each of the plurality of pixel cells receives the light only while it is exposed. The exposure timings of the pixel cells are controlled by the second controller 52. Each of the plurality of pixel cells outputs an electric signal indicative of the light received by the light receiving device. The signal level of the electric signal corresponds to the amount of light received by the light receiving device.

The second optical system 53 includes a lens that focuses the reflected light on the second light receiving unit 51, for example.

The second controller 52 may be implemented by a computer system including one or more memories and one or more processors. The functions of the second controller 52 is realized by the one or more processors of the computer system executing a program stored in the one or more memories. The program may be stored in advance in the memory, or may be provided through a telecommunications network such as the Internet, or may be provided through a non-transitory storage medium such as a memory card.

The second controller 52 is configured to control the first light emitting unit 54 and the second light receiving unit 51. The second controller 52 controls the light emission timing, the pulse width, the emission direction and the like of the first light emitting unit 54. The second controller 52 controls the exposure timing, the exposure time and the like of the second light receiving unit 51.

The second controller 52 generates, as the first 3D image of the target space S1, the first distance image 200 indicative of a distance to the object O1 present in the target space S1. The second controller 52 acquires the first distance image 200 as a following method, for example.

The second controller 52 determines the emission direction of the pulsed light of the first light emitting unit 54. Determining the emission direction leads to determine a pixel cell(s), which can receive the reflected light of the pulsed light reflected by the object O1, out of the plurality of pixel cells of the second light receiving unit 51. With one-time distance measurement, the second controller 52 acquires the electric signal(s) from this pixel cell(s).

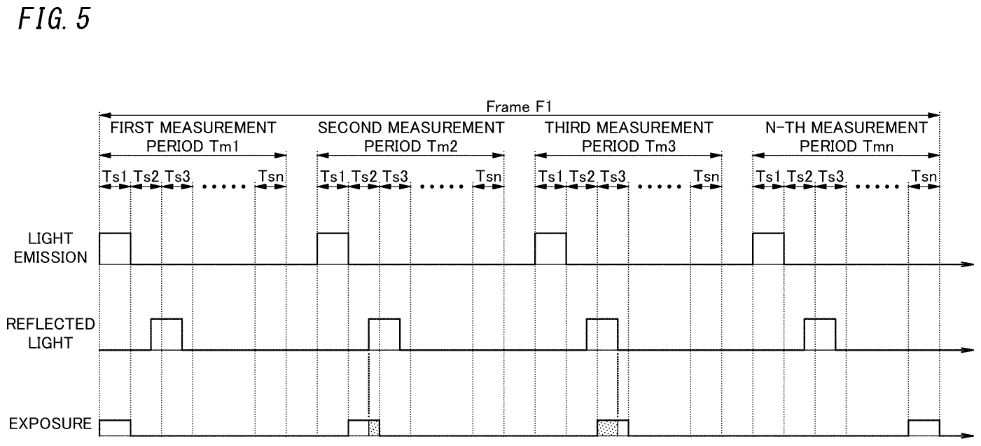

As shown in FIG. 5, the second controller 52 divides a period of time (hereinafter, referred to as “frame F1”) corresponding to the one-time distance measurement so that “n” of measurement periods are included therein (“n” is an integer greater than or equal to 2). That is, the second controller 52 divides one frame F1 so that it includes the “n” of the measurement periods, to be called a first measurement period Tm1 to a n-th measurement period Tmn. The lengths of the measurement periods are set to be the same as each other, for example.

As shown in FIG. 5, the second controller 52 further divides each of the measurement periods into “n” of divisional periods. In the embodiment, the second controller 52 divides each of the measurement periods into the “n” of divisional periods, to be called a first divisional period Ts1 to a n-th divisional period Tsn.

In each of the measurement periods, the second controller 52 controls the first light emitting unit 54 to emit the pulsed light during a first one of the divisional periods (i.e., during the first divisional period Ts1).

In each of the measurement periods, the second controller 52 controls the second light receiving unit 51 to cause (all of) the pixel cells to be exposed during any one of the first divisional period Ts1 to the n-th divisional period Tsn. With regard the first measurement period Tm1 to the n-th measurement period Tmn, the second controller 52 causes the timing during which the pixel cells are exposed to shift sequentially from the first divisional period Ts1 to the n-th divisional period Tsn one by one.

Specifically, the second controller 52 controls the exposure timings of the pixel cells such that: in the first measurement period Tm1, the pixel cells are exposed during the first divisional period Ts1; in the second measurement period Tm2, the pixel cells are exposed during the second divisional period Ts2; . . . ; and in the n-th measurement period Tmn, the pixel cells are exposed during the n-th divisional period Tsn (see FIG. 5). As a result, seen in one frame F1, the exposure of the pixel cells are performed during each of the first divisional period Ts1 to the n-th divisional period Tsn in any of the measurement periods.

The pixel cells of the second light receiving unit 51 can detect the reflected light reflected from the object O1, only while the exposure is performed. The duration of time from when the first light emitting unit 54 emits the light to when the reflected light arrives at the second light receiving unit 51 changes depending on a distance from the distance measurement unit 5 to the object O1. The reflected light arrives at the second light receiving unit 51 after the time “t=2d/c” elapses from a point in time when the first light emitting unit 54 emits light, where “d” denotes the distance from the distance measurement unit 5 to the object O1, “c” denotes the speed of light. Thus, the second controller 52 can calculate the distance to the object O1 present in the emission direction, based on the information of a divisional period during which the pixel cells of the second light receiving unit 51 receive the reflected light, in other words, based on the information of a measurement period during which the pixel cells of the second light receiving unit 51 receive the reflected light.

In the example of FIG. 5 for example, the reflected light from the object O1 arrives during a period bridging the second and third divisional periods Ts2 and Ts3, in each of the measurement periods. In this case, in the first measurement period Tm1 where the pixel cells are exposed during the first divisional period Ts1, the second light receiving unit 51 does not detect the reflected light. As a result, the signal level of the electric signal output from the pixel cell should be lower than a predetermined threshold level. On the other hand, in the second measurement period Tm2 where the pixel cells are exposed during the second divisional period Ts2 and in the third measurement period Tm3 where the pixel cells are exposed during the third divisional period Ts3, the pixel cells are exposed at timings when the reflected light arrives at the second light receiving unit 51. Therefore, the second light receiving unit 51 detects the reflected light in these measurement periods. As a result, the signal level of the electric signal output from the pixel cell is higher than or equal to the threshold level. It indicates that the second controller 52 can determine that the object O1 is present in a distance range corresponding to the second divisional period Ts2 and a distance range corresponding to the third divisional period Ts3. In other words, the second controller 52 can determine that the object O1 is present in a distance range, between: a distance (c*Ts/2) corresponding to a time when the second divisional period Ts2 starts after the first light emitting unit 54 emits light; and a distance (3*c*Ts/2) corresponding to a time when the third divisional period Ts3 ends after the first light emitting unit 54 emits light, where “Ts” denotes a length of each of the divisional period.

It is clear from the above explanation, the measurable distance of the distance measurement unit 5 (the upper limit of a distance that the distance measurement unit 5 can measure) is represented by “n*Ts*c/2”. Also, the distance resolution of the distance measurement unit 5 is represented by “Ts*c/2”.

The second controller 52 changes the emission direction of the first light emitting unit 54 (in a horizontal plane and/or vertical direction), and acquires the electric signal(s) from the pixel cell(s) corresponding to the emission direction thus changed. Consequently, in the emission direction corresponding to each of the pixel cells, the distance of the object O1 present in the target space S1 can be measured.

The second controller 52 generates, based on the electric signals output from the respective pixel cells of the second light receiving unit 51, the first distance image 200, which is an image whose pixel values of the pixels correspond to the distance to the object O1 present in the target space S1.

Explained in a different point of view, the distance measurement unit 5 divides the measurable distance into a plurality (“n”) of distance ranges, based on the distance from the distance measurement unit 5. The plurality of distance ranges includes: a first distance range (0 to Ts*c/2) corresponding to the first divisional period Ts1; a second distance range (Ts*c/2 to 2*Ts*c/2) corresponding to the second divisional period Ts2; . . . ; and a n-th distance range ((n−1)*Ts*c/2 to n*Ts*c/2) corresponding to the n-th divisional period Tsn. Furthermore, the distance measurement unit 5 generates, with respect to each distance range, a 2D image having unit pixels corresponding to the plurality of pixel cells. The 2D image generated with respect to each distance range is, for example, a binary image, whose pixel value of a pixel cell is “1” if the pixel cell receives the reflected light from the object O1 (i.e., the signal level of the pixel cell is greater than or equal to the threshold level) during a measurement period corresponding to the distance range in question, and whose pixel value of the pixel cell is “0” if the pixel cell does not receive the reflected light. The second controller 52 then colors, on a distance range basis, the plurality of 2D images corresponding to the plurality of distance ranges with different colors applied, for example, and sums up these colored images with weighted on the basis of the degree to which the signal level exceeds the threshold, thereby generating the first distance image 200.

The second controller 52 generates the first 3D data, and outputs the generated first 3D data to the signal processing unit 10. In the embodiment, the first 3D data includes first distance information indicative of the first distance image 200 thus generated. The second controller 52 outputs, as the first 3D data, the first distance information to the signal processing unit 10 (the second acquisition unit 22).

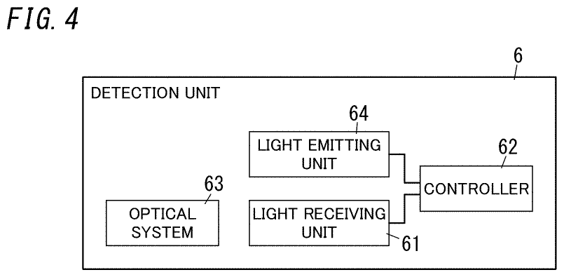

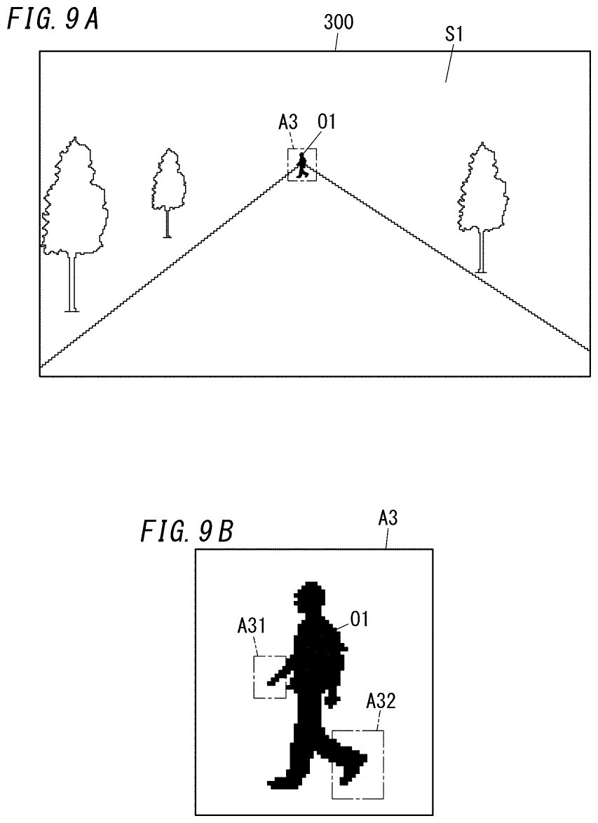

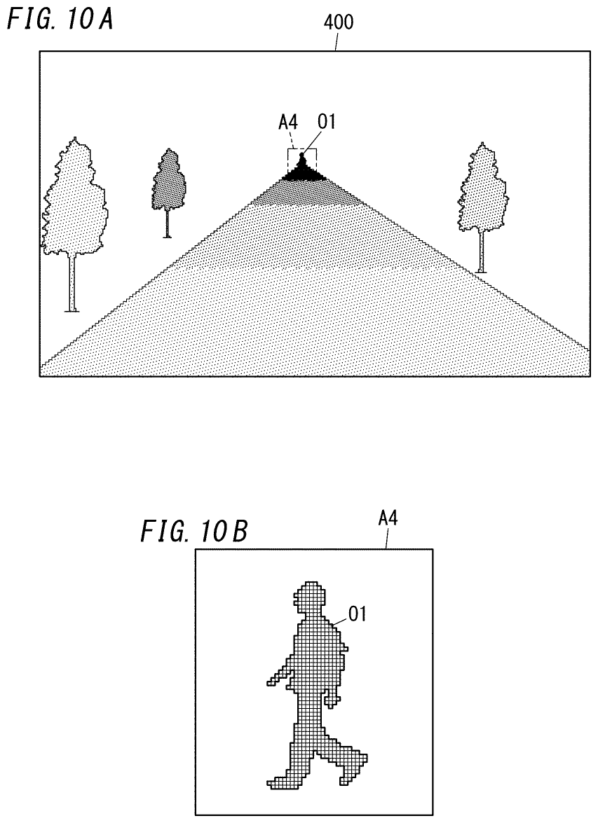

The detection unit 6 is configured to acquire the second 2D image of the target space S1. In the embodiment, the detection unit 6 acquires, as the second 2D image, a second luminance image 300 (see FIG. 9A) of the target space S1. The detection unit 6 is further configured to acquire the second 3D image of the target space S1. In the embodiment, the second 3D image is a second distance image 400. The detection unit 6 measures a distance to the object O1 based on the Time Of Flight (TOF) method to acquire the second distance image 400 (see FIG. 10A). As shown in FIG. 4, the detection unit 6 includes a light receiving unit (hereinafter, also referred to as “third light receiving unit”) 61, a controller (hereinafter, also referred to as “third controller”) 62, an optical system (hereinafter, also referred to as “third optical system”) 63, and a light emitting unit (hereinafter, also referred to as “second light emitting unit 64”).

The second light emitting unit 64 includes, as with the first light emitting unit 54, a light source (second light source) that emits a pulsed light. The light emitted from the second light emitting unit 64 may be monochromatic, with a relatively short pulse width, and a relatively high peak intensity. The wavelength of the light emitted from the second light emitting unit 64 may be within the wavelength range of the near infrared band where the human visible sensitivity is low and insusceptible to the disturbance light from sunlight. In the present embodiment, the second light emitting unit 64 includes a laser diode and emits a pulsed laser, for example. The emission timing, the pulse width, the emission direction and the like of the second light emitting unit 64 are controlled by the third controller 62.

The third light receiving unit 61 includes, as with the second light receiving unit 51, a solid-state imaging device. The third light receiving unit 61 receives a reflected light, which is the light emitted from the second light emitting unit 64 and reflected by an object O1. The third light receiving unit 61 includes a plurality of pixel cells arranged in a 2D array. For example, the number of pixel cells that the third light receiving unit 61 includes is smaller than the number of pixel cells that the first light receiving unit 41 includes, and also is smaller than the number of pixel cells that the second light receiving unit 51 includes. Each of the plurality of pixel cells includes a light receiving device such as a photodiode. The light receiving device may be an avalanche photodiode. Each of the plurality of pixel cells receives the light only while it is exposed. The exposure timings of the pixel cells are controlled by the third controller 62. Each of the plurality of pixel cells outputs an electric signal indicative of the light received by the light receiving device. The signal level of the electric signal corresponds to the amount of light received by the light receiving device.

The third optical system 63 includes a lens that focuses the external light and the reflected light on the third light receiving unit 61, for example.

The third controller 62 may be implemented by a computer system including one or more memories and one or more processors. The functions of the third controller 62 is realized by the one or more processors of the computer system executing a program stored in the one or more memories. The program may be stored in advance in the memory, or may be provided through a telecommunications network such as the Internet, or may be provided through a non-transitory storage medium such as a memory card.

The third controller 62 is configured to control the second light emitting unit 64 and the third light receiving unit 61. The third controller 62 controls the light emission timing, the pulse width, the emission direction and the like of the second light emitting unit 64. The third controller 62 controls the exposure timing, the exposure time and the like of the third light receiving unit 61.

The third controller 62 determines the emission direction of the pulsed light emitted from the second light emitting unit 64, and specifies a pixel cell(s) which can receive the reflected light of the pulsed light, out of the plurality of pixel cells of the third light receiving unit 61. With one-time distance measurement, the third controller 62 acquires the electric signal(s) from this pixel cell(s).

The third controller 62 divides a period of time corresponding to the one-time distance measurement so that “x” of measurement periods (“x” is an integer greater than or equal to 2) are included therein, and further divides each of the measurement periods into “x” of divisional periods. In each of the measurement periods, the third controller 62 controls the second light emitting unit 64 to emit the pulsed light during a first one of the divisional periods. The third controller 62 also controls the third light receiving unit 61 to cause the pixel cells to be exposed during mutually different divisional periods with regard to the plurality of measurement periods. In the embodiment, a length Tt of the divisional period for the detection unit 6 performing the distance measurement is longer than the length Ts of the divisional period for the distance measurement unit 5. The third controller 62 acquires, with respect to each measurement period, the electric signal(s) from the pixel cell(s) corresponding to the emission direction of the third light receiving unit 61.

The third controller 62 changes the emission direction of the second light emitting unit 64 and changes the pixel cell(s) of the plurality of pixel cells of the third light receiving unit 61 from which the electric signal(s) is to be acquired, and performs the above measurement for each of the plurality of pixel cells. Thus, the third controller 62 generates a plurality of 2D images corresponding respectively to the plurality of measurement periods. As with explained for the distance measurement unit 5, the plurality of measurement periods correspond respectively to a plurality of distance ranges that divide the target space S1 based on a distance from the detection unit 6. A pixel value for a pixel cell of each 2D image corresponds to the amount of light received by the pixel cell in question during a corresponding measurement period.

The third controller 62 sums up, with respect to each pixel cell, the pixel values of the pixel cell in question for the plurality of 2D images (correspond to the plurality of distance ranges), thereby generating the second luminance image 300. In other words, the detection unit 6 generates the second luminance image 300 (the second 2D image) by combining the plurality of 2D images together without identifying the distance ranges of the plurality of 2D images.

Furthermore, the third controller 62 generates a plurality of binary images from the plurality of 2D images, based on a comparison between a pixel value of each pixel cell and a predetermined threshold. The plurality of binary images correspond one-to-one to the plurality of 2D images (i.e., the plurality of distance ranges). The binary image is an image whose pixel value is “1” if the pixel value of the pixel cell of a corresponding 2D image is greater than or equal to the threshold and “0” if the pixel value thereof is smaller than the threshold. Furthermore, with regard to each binary image, the third controller 62 allocates, to a pixel whose pixel value is “1”, a pixel value which is determined depending on a distance range (i.e., a measurement period) of the binary image in question. For example, the third controller 62 determines the pixel values for the plurality of binary images so that the binary image far away from the detection unit 6 has a larger pixel value. That is, the third controller 62 colors the plurality of binary images according to their distance ranges. The third controller 62 sums up, with regard to each pixel cell, the pixel values of the plurality of binary images with weighted on the basis of the degree to which the pixel value exceeds the threshold level, thereby generating the second distance image 400. In short, the detection unit 6 generates the second distance image 400 (the second 3D image) by combining the plurality of 2D images together while identifying the distance ranges of the plurality of 2D images.

As described above, the detection unit 6 generates both of the second luminance image 300 and the second distance image 400, based on the amount of light received by the same pixel cell. Furthermore, the second luminance image 300 and the second distance image 400 are generated from the same set of 2D images. This means that, positions in the target space S1 corresponding to pixels of the second luminance image 300 and positions in the target space S1 corresponding to pixels of the second distance image 400 correspond one-to-one to each other. Moreover, the plurality of pixels of the second luminance image 300 (the second 2D image) and the plurality of pixels of the second distance image 400 (the second 3D image) correspond one-to-one to each other.

The third controller 62 generates the second 2D data and outputs the generated second 2D data to the signal processing unit 10. In the embodiment, the second 2D data includes second luminance information indicative of the generated second luminance image 300. The third controller 62 outputs, as the second 2D data, the second luminance information to the signal processing unit 10 (the third acquisition unit 23). The third controller 62 generates the second 3D data and output the generated second 3D data to the signal processing unit 10. In the embodiment, the second 3D data includes second distance information indicative of the generated second distance image 400. The third controller 62 outputs, as the second 3D data, the second distance information to the signal processing unit 10 (the third acquisition unit 23).

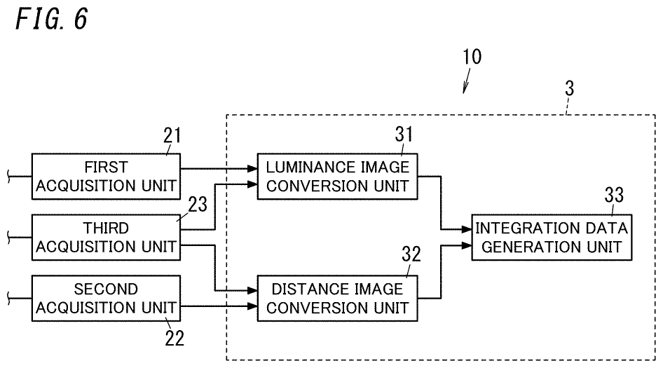

As shown in FIG. 6, the signal processing unit 10 includes the first acquisition unit 21 to the third acquisition unit 23 and the computation unit 3.

The first acquisition unit 21 acquires the first 2D data from the imaging unit 4. In the embodiment, the first acquisition unit 21 acquires, as the first 2D data, the first luminance information indicative of the first luminance image 100, from the imaging unit 4. The first luminance information includes information where: a numerical value indicative of the magnitude of luminance is assigned to a position (coordinates) of each of pixels of the first luminance image 100, as the pixel value, for example.

The second acquisition unit 22 acquires the first 3D data from the distance measurement unit 5. In the embodiment, the second acquisition unit 22 acquires, as the first 3D data, the first distance information indicative of the first distance image 200, from the distance measurement unit 5. The first distance information includes information where a numerical value indicative of the amount of distance is assigned: to a position (coordinates) of each of pixels of the first distance image 100, as the pixel value, for example.

The third acquisition unit 23 acquires the second 2D data from the detection unit 6. In the embodiment, the third acquisition unit 23 acquires, as the second 2D data, the second luminance information indicative of the second luminance image 300, from the detection unit 6. The second luminance information includes information where: a numerical value indicative of the magnitude of luminance is assigned to a position (coordinates) of each of pixels of the second luminance image 300, as the pixel value, for example. The third acquisition unit 23 acquires the second 3D data from the detection unit 6. In the embodiment, the third acquisition unit 23 acquires, as the second 3D data, the second distance information indicative of the second distance image 400, from the detection unit 6. The second distance information includes information where: a numerical value indicative of the amount of distance is assigned to a position (coordinates) of each of pixels of the second distance image 400, as the pixel value, for example.

As shown in FIG. 6, the computation unit 3 includes: a luminance image conversion unit 31 serving as a 2D image conversion unit; a distance image conversion unit 32 serving as a 3D image conversion unit; and the integration data generation unit 33. The computation unit 3 may be implemented by a computer system including one or more memories and one or more processors. The functions of the units (the luminance image conversion unit 31, the distance image conversion unit 32, and the integration data generation unit 33) of the computation unit 3 is realized by the one or more processors of the computer system executing a program stored in the one or more memories. The program may be stored in advance in the memory, or may be provided through a telecommunications network such as the Internet, or may be provided through a non-transitory storage medium such as a memory card.

The luminance image conversion unit 31 performs conversion of assigning a pixel value of each of pixels of the first luminance image 100 to an associated pixel region of the second luminance image 300 to generate a calculated luminance image. That is, the 2D image conversion unit performs conversion of assigning a pixel value of each of pixels of the first 2D image to an associated pixel region of the second 2D image to generate a calculated 2D image.

The distance image conversion unit 32 performs conversion of assigning a pixel value of each of pixels of the first distance image 200 to an associated pixel region of the second distance image 400 to generate a calculated distance image. That is, the 3D image conversion unit performs conversion of assigning a pixel value of each of pixels of the first 3D image to an associated pixel region of the second 3D image to generate a calculated 3D image.

The integration data generation unit 33 generates, based on the calculated luminance image and the calculated distance image, integration data associating the first luminance information and the first distance information with each other. That is, the integration data generation unit 33 generates, based on the calculated 2D image and the calculated 3D image, integration data associating the first 2D data and the first 3D data with each other.

It will be explained an operation of the computation unit 3 with reference to FIG. 7A to FIG. 10B.

In the embodiment, the distance measurement imaging system 1 (including the imaging unit 4, the distance measurement unit 5, the detection unit 6, and the signal processing unit 10) is installed on an automobile, and a human as the object O1 is present in the target space Si in front of the automobile.

The imaging unit 4 captures an image of the target space S1 to acquire the first luminance image 100 as shown in FIG. 7A and FIG. 7B, for example. As shown in FIG. 7A and FIG. 7B, the imaging unit 4 generates the first luminance image 100 including the object O1, with a resolution determined depending e.g., on the pixel number (the number of pixel cells) of the first light receiving unit 41. Note that the first luminance image 100 does not have the information about the distance to the object O1.

The distance measurement unit 5 receives, with the plurality of pixel cells of the second light receiving unit 51, the reflected light of the light emitted from the first light emitting unit 54 and reflected from the target space S1, and performs the processing on the received light, to generate the first distance image 200 as shown in FIG. 8A an FIG. 8B. The first distance image 200 can identify the distance to the object O1 with a resolution determined depending e.g., on the length Ts of the divisional period of the distance measurement unit 5. The resolution may be 3 [m] when the length Ts of the divisional period is 20 [ns], for example. FIG. 8A illustrates the distance from the distance measurement unit 5 to the objects present in the first distance image 200 such that the object far apart from the distance measurement unit 5 is colored more darker.

The detection unit 6 receives, with the third light receiving unit 61, the reflected light of the light emitted from the second light emitting unit 64 and reflected from the target space S1, and performs processing on the received light, to generate the second luminance image 300 as shown in FIG. 9A an FIG. 9B and the second distance image 400 as shown in FIG. 10A and FIG. 10B. As described above, the pixels of the second luminance image 300 and the pixels of the second distance image 400 are corresponding one-to-one to each other. The pixel number of the third light receiving unit 61 of the detection unit 6 is smaller than the pixel number of the first light receiving unit 41 of the imaging unit 4 and thus the resolution of the second luminance image 300 is smaller than the resolution of the first luminance image 100. That is, the imaging unit 4 and the detection unit 6 have mutually different spatial resolutions (in the embodiment, the imaging unit 4 has a relatively greater spatial resolution). The length Tt of the divisional period for the distance measurement of the detection unit 6 is longer than the length Ts of the divisional period for that of the distance measurement unit 5, and thus the resolution (distance resolution) of the second distance image 400 is smaller than the resolution of the first distance image 200. That is, the distance measurement unit 5 and the detection unit 6 have mutually different distance resolutions (in the embodiment, the distance measurement unit 5 has a relatively high distance resolution). The length Tt of the divisional period for the detection unit 6 may be 100 [ns], and the resolution of the distance may be 15 [m], for example.

The luminance image conversion unit 31 extracts, from each of the first luminance image 100 and the second luminance image 300, the feature quantity such as an outline of the object O1, and performs matching between the feature quantities of the luminance images to make an association between a plurality of pixels of the first luminance image 100 and a plurality of pixels of the second luminance image 300, for example. For example, the luminance image conversion unit 31 determines that a pixel range A11 of FIG. 7B corresponds to a pixel range A31 of FIG. 9B based on the extracted feature quantities, and associates pixels of the pixel range A11 of the first luminance image 100 and pixels of the pixel range A31 of the second luminance image 300. Furthermore, the luminance image conversion unit 31 determines that a pixel range A12 of FIG. 7B corresponds to a pixel range A32 of FIG. 9B based on the extracted feature quantities, and associates pixels of the pixel range A12 of the first luminance image 100 and pixels of the pixel range A32 of the second luminance image 300 with each other. As such, the plurality of pixels of the first luminance image 100 and the plurality of the second luminance image 300 are associated with each other. In an example case where the pixel number of the first luminance image 100 and the pixel number of the second luminance image 300 are the same as each other and the imaging unit 4 and the detection unit 6 capture the images of the same target space S1, the plurality of pixels of the first luminance image 100 and the plurality of pixels of the second luminance image 300 may be associated one-to-one with each other. In another example case where the pixel number of the first luminance image 100 is twice the pixel number of the second luminance image 300 in both the lateral direction and the transverse direction and the imaging unit 4 and the detection unit 6 capture the images of the same target space S1, one pixel of the second luminance image 300 may be associated with four (2 by 2) pixels of the first luminance image 100.

After completion of the association, the luminance image conversion unit 31 performs conversion of assigning a pixel value of each of pixels of the first luminance image 100 to an associated pixel region of the second luminance image 300 to generate the calculated luminance image. As a result, the calculated luminance image can be generated where each coordinates of the pixel of the second luminance image 300 is associated with the pixel value(s) of the pixel(s) of the first luminance image 100. That is, the calculated 2D image can be generated where each coordinates of the pixel of the second 2D image is associated with the pixel value(s) of the pixel(s) of the first 2D image.

According to the calculated luminance image (the calculated 2D image) thus generated, the pixel value(s) of the pixel(s) of the first luminance image 100 (the first 2D image) is assigned to any of the pixel region of the second luminance image 300 (the second 2D image).

The distance image conversion unit 32 compares information of a distance of an object O1 contained in the first distance image 200 and information of a distance of an object O1 contained in the second distance image 400, and makes an association between the object O1 contained in the first distance image 200 and the object O1 contained in the second distance image 400, for example. In the embodiment, the distance image conversion unit 32 determines that when, in the second distance image 400, there are a plurality of pixels having the signal level grater than the threshold level in the same distance range and continuous with each other, a single object O1 is present in a region corresponding to these continuous pixels (see the Object O1 shown in FIG. 10B). Furthermore, the distance image conversion unit 32 determines that when a distance of an object O1 contained in the first distance image 200 is included in a distance of an object O1 contained in the second distance image 400 or vice verse, these objects O1 may be the same object as each other. In an example case, it is supposed that there is a plurality of pixels that indicates a presence of an object O1 in a distance range of 294 to 297 [m], within a region A2 in the first distance image 200, as shown in FIG. 8A. In the example case, it is also supposed that there is continuous pixels that indicate a presence of an object O1 in a distance range of 270 to 300 [m], within a region A4 in the second distance image 400, as shown in FIG. 10A. In this case, the distance image conversion unit 32 determines that the object O1 within the region A2 and the object O1 within the region A4 may be the same object O1. The distance image conversion unit 32 performs such a determination for a plurality of objects, and on the basis of this determination, determines positional relations between the plurality of objects O1 contained in the first distance image 200 and the plurality of objects O1 contained in the second distance image 400. Based on the positional relations of these objects, the distance image conversion unit 32 makes the association between the plurality of pixels of the first distance image 200 and the plurality of pixels of the second luminance image 300 to improve the accuracy of the distance. Specifically, the distance range of the above mentioned object O1 of FIG. 10B is corrected from 270 to 300 [m] to 294 to 297 [m]. As with the above described case for the calculated luminance image, in an example case where the pixel number of the first distance image 200 and the pixel number of the second distance image 400 are the same as each other and the distance measurement unit 5 and the detection unit 6 receive the reflected lights from the same target space S1, the plurality of pixels of the first distance image 200 and the plurality of pixels of the second distance image 400 may be associated one-to-one with each other. In another example case where the pixel number of the first distance image 200 is twice the pixel number of the second distance image 400 in both the lateral direction and the transverse direction and the distance measurement unit 5 and the detection unit 6 receive the reflected lights from the same target space S1, one pixel of the second distance image 400 may be associated with four (2 by 2) pixels of the first distance image 200.

After completion of the association, the distance image conversion unit 32 performs conversion of assigning a pixel value of each of pixels of the first distance image 200 to an associated pixel region of the second distance image 400 to generate the calculated distance image. As a result, the calculated distance image can be generated where each coordinates of the pixel of the second distance image 400 is associated with the pixel value(s) of the pixel(s) of the first distance image 200. That is, the calculated 3D image can be generated where each coordinates of the pixel of the second 3D image is associated with the pixel value(s) of the pixel(s) of the first 3D image.

According to the calculated distance image (the calculated 3D image) thus generated, the pixel value(s) of the pixel(s) of the first distance image 200 (the first 3D image) is preferentially assigned to any of the pixel region of the second distance image 400 (the second 3D image).

The integration data generation unit 33 generates, based on the calculated luminance image and the calculated distance image, the integration data associating the information on the first luminance image 100 and the information on the first distance image 200 with each other.

As described above, the second luminance image 300 and the second distance image 400 have the same pixel number, and the plurality of pixel of the second luminance image 300 and the plurality of pixels of the second distance image 400 correspond one-to-one to each other. The integration data generation unit 33 makes an association between: a pixel value(s) of a pixel(s) of the first luminance image 100 associated with a certain pixel region of the second luminance image 300; and a pixel value(s) of a pixel(s) of the first distance image 200 associated with a pixel region of the second distance image 400 that has been associated to the certain pixel region (of the second luminance image 300). In short, the integration data generation unit 33 makes an association between the plurality of pixels of the first luminance image 100 and the plurality of pixels of the first distance image 200, with the second luminance image 300 and the second distance image 400 generated by the detection unit 6 used as a bridge.

The integration data generation unit 33 thus generates the integration data associating the first luminance information and the first distance information with each other (the integration data associating the first 2D data and the first 3D data with each other). The information indicated by the integration data thus generated may be displayed, as a stereoscopic image, for example.

As described above, according to the distance measurement imaging system 1 of the present embodiment, the first 2D data and the first 3D data are associated with each other through the second 2D data and the second 3D data acquired by the detection unit 6. It is accordingly possible to obtain data (the integration data) associating luminance information (the first luminance information) and distance information (the first distance information) with each other, in other words, possible to obtain data (the integration data) associating 2D data (the first 2D data) and 3D data (the first 3D data) with each other.

Moreover, it is possible to make an association between the first luminance image 100 and the second luminance image 300 with the use of the second luminance information and the second distance information, even when the pixel number of the first luminance image 100 and the pixel number of the first distance image 200 are different from each other. That is, the first 2D image and the second 3D image can be associated with each other through the second 2D data and the second 3D data.

### (3) Variation

The embodiment described above is mere an example of various embodiments of the present disclosure. The above embodiment may be modified in various ways in accordance with design or the like as long as the object of the present disclosure can be achieved.

(3.1) First Variation

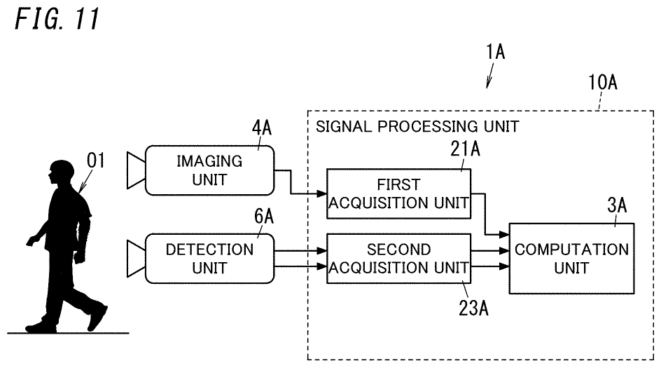

A distance measurement imaging system 1A and a distance measurement method of the present variation is described with reference to FIG. 11.

As shown in FIG. 11, the distance measurement imaging system 1A of this variation includes a signal processing unit 10A. The signal processing unit 10A includes a first acquisition unit 21A, a second acquisition unit 23A, and a computation unit 3A. The second acquisition unit 23A is comparable to the third acquisition unit 23 of the embodiment described above. Accordingly, the distance measurement imaging system 1A of the present variation does not include components corresponding to the second acquisition unit 22 and the distance measurement unit 5 of the distance measurement imaging system 1 of the above described embodiment. Components of the distance measurement imaging system 1A of this variation common to those of the distance measurement imaging system 1 of the embodiment described above are assigned to the same numerals followed by a letter “A”, and explained thereof may be appropriately omitted.

The first acquisition unit 21A is configured to acquire first 2D data. The first acquisition unit 21A is configured to be connected to an imaging unit 4A, for example. The first acquisition unit 21A acquires the first 2D data from the imaging unit 4A, for example. The first 2D data includes information about a first 2D image of a target space S1, for example. The first 2D image is a first luminance image 100A of the target space S1, for example.

The second acquisition unit 23A is configured to acquire second 2D data and first 3D data with a coaxial optical system. The second acquisition unit 23A is configured to be connected to a detection unit 6A, for example. The second acquisition unit 23A acquires, from the detection unit 6A, the second 2D data and the first 3D data with the coaxial optical system, for example. The second 2D data includes information about a second 2D image of the target space S1, for example. The second 2D image is a second luminance image 300A of the target space S1, for example. The first 3D data includes information about a first 3D image of the target space S1, for example. The first 3D image is an image indicative of a distance to an object O1 present in the target space S1. The first 3D image is a first distance image 400A of the target space S1, for example.

The computation unit 3A is configured to execute a processing for making an association between the first 2D data and the second 2D data and a processing for making an association between the first 2D data and the first 3D data.

Specifically, the computation unit 3A includes a 2D data conversion unit and an integration data generation unit.

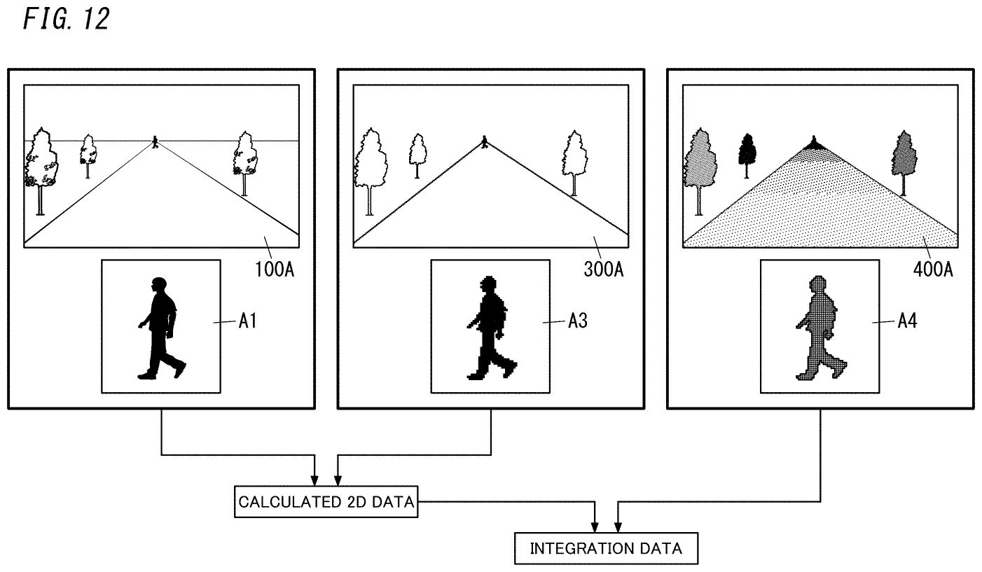

As shown in FIG. 12, the 2D data conversion unit makes an association between the first 2D data acquired by the first acquisition unit 21A and the second 2D data acquired by the second acquisition unit 23A to generate calculated 2D data. Specifically, the 2D data conversion unit performs conversion of assigning a pixel value of each of pixels of the first 2D image (the first luminance image 100A) to an associated pixel region of the second 2D image (the second luminance image 300A) to generate a calculated 2D image (a calculated luminance image). That is, the 2D data conversion unit executes a processing for making an association between the first 2D data and the second 2D data by performing conversion of assigning a pixel value of each of pixels of the first 2D data to an associated pixel region of the second 2D data to generate the calculated 2D data.

As shown in FIG. 12, the integration data generation unit generates, based on the calculated 2D image and the first 3D image (the first distance image 400A), the integration data associating the first 2D data and the first 3D data with each other. That is, the integration data generation unit generates, based on the calculated 2D data and the first 3D data, the integration data associating the first 2D data and the first 3D data with each other.

As with the detection unit 6, the detection unit 6A generates both of the second luminance image 300A and the first distance image 400A, based on the amount of light received by the same pixel cell. Furthermore, the second luminance image 300A and the first distance image 400A are generated from the same set of 2D images. This means that, a plurality of pixels of the second luminance image 300A (the second 2D data) and a plurality of pixels of the first distance image 400A (the first 3D data) are correspond one-to-one to each other.

According to the distance measurement imaging system 1A of the present variation, the first 2D data and the first 3D data are associated with each other through the second 2D data acquired by the detection unit 6A. It is accordingly possible to obtain data associating 2D data (the first 2D image) and 3D data (the first 3D image) with each other.

According to the distance measurement imaging system 1A of the present variation, the second 2D data and the first 3D data can be acquired in one-to-one correspondence with the coaxial optical system by the second acquisition unit 23A, which leads to omission of complex mechanisms. Furthermore, it may be easy to make an association between the first 2D data of the first acquisition unit 21A and the second 2D data of the second acquisition unit 23A compared to a case of making an association between 3D data and another 3D data.

(3.2) Other Variations

Functions of the distance measurement imaging system 1, 1A, the computation unit 3, or 3A may be realized by a distance measurement imaging method, a (computer) program, a non-transitory storage medium recording a program.

A distance measurement imaging method according to one aspect includes a first acquisition step, a second acquisition step, a third acquisition step, and a processing step. The first acquisition step includes acquiring first 2D data from an imaging unit 4 that acquires a first 2D image of a target space S1. The second acquisition step includes acquiring first 3D data from a distance measurement unit 5 that acquires a first 3D image of the target space S1. The third acquisition step includes acquiring second 2D data and second 3D data from a detection unit 6 that acquires a second 2D image and a second 3D image of the target space S1 with a coaxial optical system. The processing step includes executing a processing for making an association between the first 2D data and the second 2D data and a processing for making an association between the first 3D data and the second 3D data.

A distance measurement imaging method according to one aspect includes a first acquisition step, a second acquisition step, and a processing step. The first acquisition step includes acquiring first 2D data. The second acquisition step includes acquiring second 2D data and first 3D data. The processing step includes executing a processing for making an association between the first 2D data and the second 2D data and a processing for making an association between the first 2D data and the first 3D data.

A program according to one aspect is a program configured to cause one or more processors to execute the distance measurement imaging method described above.

Other variations will be described hereinbelow. These variations are explained based mainly on the distance measurement imaging system 1 of the embodiment, but can be applied to the distance measurement imaging system 1A of the first variation.

The distance measurement imaging system 1 of the present disclosure includes a computer system in, for example, the first the first controller 42 of the imaging unit 4, the second controller 52 of the distance measurement unit 5, the third controller 62 of the detection unit 6, the computation unit 3, and the like. The computer system includes, as main components, a processor and memory as hardware. The functions as the first controller 42, the second controller 52, the third controller 62, the computation unit 3, or the like according to the present disclosure may be realized as a result of the processor executing a program stored in the memory of the computer system. The program may be stored in the memory of the computer system in advance or may be provided through a telecommunications network, or be distributed through a non-transitory computer readable storage medium such as a memory card, an optical disc, or a hard disk drive that records the program. The processor of the computer system includes one or more electronic circuits including a semiconductor integrated circuit (IC) or a large-scale integrated circuit (LSI). The integrated circuit such as IC or LSI stated herein is called differently according to integration, and may include an integrated circuit called system LSI, very large scale integration (VLSI) or ultra large scale integration (ULSI). In addition, a field programmable gate array (FPGA) to be programmed after production of LSI, or a logic device that allows reconfiguration of connection relationship inside LSI or reconstruction of the circuit partition inside LSI. The electronic circuits may be integrated on one chip, or provided on chips in a distributed manner. The chips may be consolidated into one device, or provided in devices in a distributed manner. The computer system stated herein include s a micro controller containing one or more processors and one or more memories. The microcontroller may therefore be composed of one or more electronic circuits including a semiconductor integrated circuit or a large scale integrated circuit.

It is not essential for the distance measurement imaging system 1 that functions provided for the distance measurement imaging system 1 are consolidated into one housing. The components of the distance measurement imaging system 1 may be provided in housings in a distributed manner. Moreover, at least part of the functions of the distance measurement imaging system 1, such as the computation unit 3, may be realized by, for example, a server system, a cloud (cloud computing) service, or the like. Alternatively, all of the functions of the distance measurement imaging system 1 may be consolidated into one housing as the embodiment described above.

The first acquisition unit 21 to the third acquisition unit 23 may be implemented by the same communications interface, or may be implemented by mutually different communications interfaces. The third acquisition unit 23 may includes a communications interface for acquiring the second luminance information and another communications interface for acquiring the second distance information. Any one of the first acquisition unit 21 to the third acquisition unit 23 is not limited to the communications interface, but may be an electric wire interconnecting the imaging unit 4, the distance measurement unit 5, or the detection unit 6 to the computation unit 3.

The first controller 42 is not limited to generate the first luminance image 100 (the first 2D image). The first controller 42 may output, as the first luminance information (the first 2D data), information from which the first luminance image 100 (the first 2D image) can be generated. The second controller 52 is not limited to generate the first distance image 200 (the first 3D image). The second controller 52 may output, as the first distance information (the first 3D data), information from which the first distance image 200 (the first 3D image) can be generated. The third controller 62 is not limited to generate the second luminance image 300 (the second 2D image). The third controller 62 may output, as the second luminance information (the second 2D data), information from which the second luminance image 300 (the second 2D image) can be generated. The third controller 62 is not limited to generate the second distance image 400 (the second 3D image). The third controller 62 may output, as the second distance information (the second 3D data), information from which the second distance image 400 (the second 3D image) can be generated. The controller of the detection unit 6A is not limited to generate the first distance image 400A (the first 3D image). The controller of the detection unit 6A may output, as the first distance information (the first 3D data), information from which the first distance image 400A (the first 3D image) can be generated.

The integration data includes, as its internal data, the pixel values of the respective pixels of the second luminance image 300, the pixel values of the respective pixels of the second distance image 400, and the like. In this case, if a certain pixel in the first luminance image 100 has an erroneous pixel value, the pixel value of this pixel may be a pixel value for the second luminance image 300, for example.

The resolution (the pixel number) of the first luminance image 100 and the resolution (the pixel number) of the second luminance image 300 may be same as each other or may be different from each other. The resolution (distance resolution) of the first distance image 200 and the resolution (distance resolution) of the second distance image 400 may be same as each other or may be different from each other.

The plurality of pixel cells of the imaging unit 4 and the plurality of pixel cells of the detection unit 6 may be associated with each other in advance. The computation unit 3 may, based on the preliminarily determined relation between the pixel cells of the imaging unit 4 and the pixel cells of the detection unit 6, associate the first luminance image 100 and the second luminance image with each other. The plurality of pixel cells of the distance measurement unit 5 and the plurality of pixel cells of the detection unit 6 may be associated with each other in advance. The computation unit 3 may, based on the preliminarily determined relation between the pixel cells of the distance measurement unit 5 and the pixel cells of the detection unit 6, make an association between the first distance image 200 and the second distance image 400.

### (4) Summary

It is apparent from the embodiment and variations described above, following aspects are disclosed in the disclosure.

A distance measurement imaging system (1) of a first aspect includes a first acquisition unit (21), a second acquisition unit (22), a third acquisition unit (23), and a computation unit (3). The first acquisition unit (21) is configured to acquire first 2D data from an imaging unit (4). The imaging unit (4) is configured to acquire a first 2D image of a target space (S1). The second acquisition unit (22) is configured to acquire first 3D data from a distance measurement unit (5). The distance measurement unit (5) is configured to acquire a first 3D image of the target space (S1). The third acquisition unit (23) is configured to acquire second 2D data and second 3D data from a detection unit (6). The detection unit (6) is configured to acquire a second 2D image and a second 3D image of the target space (S1) with a coaxial optical system. The computation unit (3) is configured to execute a processing for making an association between the first 2D data and the second 2D data and a processing for making an association between the first 3D data and the second 3D data.

With this aspect, the first 2D data and the first 3D data are associated with each other through the second 2D data and the second 3D data acquired by the detection unit (6). It is accordingly possible to obtain the data associating 2D data (the first 2D data) and 3D data (the first 3D data) with each other.

In the distance measurement imaging system (1) of a second aspect, in accordance with the first aspect, the computation unit (3) includes a 2D image conversion unit (luminance image conversion unit 31), a 3D image conversion unit (distance image conversion unit 32), and an integration data generation unit (33). The 2D image conversion unit is configured to perform conversion of assigning a pixel value of each of pixels of the first 2D image to an associated pixel region of the second 2D image to generate a calculated 2D image. The 3D image conversion unit is configured to perform conversion of assigning a pixel value of each of pixels of the first 3D image to an associated pixel region of the second 3D image to generate a calculated 3D image. The integration data generation unit (33) is configured to generate, based on the calculated 2D image and the calculated 3D image, integration data associating the first 2D data and the first 3D data with each other.

With this aspect, it is possible to obtain the data associating the first 2D data and the first 3D data with each other.

In the distance measurement imaging system (1) of a third aspect, in accordance with the first or second aspect, the detection unit (6) is configured to divide the target space (S1) into a plurality of distance ranges based on a distance from the detection unit (6), and to generate a plurality of 2D images that corresponds respectively to the plurality of distance ranges. The detection unit (6) is configured to generate the second 2D image by combining the plurality of 2D images together without identifying the distance ranges of the plurality of 2D images. The detection unit (6) is configured to generate the second 3D image by combining the plurality of 2D images together while identifying the distance ranges of the plurality of 2D images. A plurality of pixels of the second 2D image and a plurality of pixels of the second 3D image correspond to each other in one-to-one relation.

With this aspect, the second 2D image and the second 3D image are generated from the same set of 2D images, leading to make easy to make an association between the second 2D image and the second 3D image.

In the distance measurement imaging system (1) of a fourth aspect, in accordance with any one of the first to third aspects, the imaging unit (4) and the detection unit (6) have mutually different optical axes, and the distance measurement unit (5) and the detection unit (6) have mutually different optical axes.

With this aspect, it is possible to make an association between an 2D image (the first 2D image) and a 3D image (the first 3D image), with a system where the first 2D image, the first 3D image, the second 2D image, and the second 3D image are generated with the imaging unit (4), the distance measurement unit (5), and the detection unit (6) having mutually different optical axes.

In the distance measurement imaging system (1) of a fifth aspect, in accordance with any one of the first to fourth aspects, the imaging unit (4) and the detection unit (6) have mutually different spatial resolutions, and the distance measurement unit (5) and the detection unit (6) have mutually different distance resolutions.

With this aspect, it is possible to make an association between an 2D image (the first 2D image) and a 3D image (the first 3D image), with a system where the imaging unit (4) and the detection unit (6) have mutually different spatial resolutions and the distance measurement unit (5) and the detection unit (6) have mutually different distance resolutions.

The distance measurement imaging system (1) of a sixth aspect, in accordance with any one of the first to fifth aspects, further includes at least one of the imaging unit (4), the distance measurement unit (5), or the detection unit (6).

With this aspect, it is possible to obtain data associating 2D data (the first 2D data) and 3D data (the first 3D data) with each other. The distance measurement imaging system (1) may further include any two of the imaging unit (4), the distance measurement unit (5), and the detection unit (6), or all of the imaging unit (4), the distance measurement unit (5), and the detection unit (6).

A distance measurement imaging method of a seventh aspect includes a first acquisition step, a second acquisition step, a third acquisition step, and a processing step. The first acquisition step includes acquiring first 2D data from an imaging unit (4) that acquires a first 2D image of a target space (S1). The second acquisition step includes acquiring first 3D data from a distance measurement unit (5) that acquires a first 3D image of the target space (S1). The third acquisition step includes acquiring second 2D data and second 3D data from a detection unit (6). The detection unit (6) acquires a second 2D image and a second 3D image of the target space (S1) with a coaxial optical system. The processing step includes executing a processing for making an association between the first 2D data and the second 2D data and a processing for making an association between the first 3D data and the second 3D data.

With this aspect, it is possible to obtain data associating between 2D data (the first 2D data) and 3D data (the first 3D data).

A program of an eighth aspect is a program configured to cause one or more processors to execute the distance measurement imaging method of the seventh aspect.

With this aspect, it is possible to obtain data associating 2D data (the first 2D data) and 3D data (the first 3D data) with each other.

A distance measurement imaging system (1A) of a ninth aspect includes a first acquisition unit (21A), a second acquisition unit (23A), and a computation unit (3A). The first acquisition unit (21A) is configured to acquire first 2D data. The second acquisition unit (23A) is configured to acquire second 2D data and first 3D data with a coaxial optical system. The computation unit (3A) is configured to execute a processing for making an association between the first 2D data and the second 2D data and a processing for making an association between the first 2D data and the first 3D data.

With this aspect, it is possible to obtain data associating 2D data (the first 2D data) and 3D data (the first 3D data) with each other.

In the distance measurement imaging system (1A) of a tenth aspect, in accordance with the ninth aspect, the computation unit (3A) includes a 2D data conversion unit and an integration data generation unit. The 2D data conversion unit is configured to execute a processing for making an association between the first 2D data and the second 2D data with each other by performing conversion of assigning a pixel value of each of pixels of the first 2D data to an associated pixel region of the second 2D data to generate a calculated 2D data. The integration data generation unit is configured to generate, based on the calculated 2D data and the first 3D data, integration data associating the first 2D data and the first 3D data with each other.

With this aspect, it is possible to obtain the integration data associating 2D data (the first 2D data) and 3D data (the first 3D data) with each other.

In the distance measurement imaging system (1A) of an eleventh aspect, in accordance with the ninth or tenth aspect, a plurality of pixels of the second 2D data and a plurality of pixels of the first 3D data correspond to each other in one-to-one relation.

With this aspect, making an association between the second 2D data and the second 3D data is easy.

In the distance measurement imaging system (1A) of a twelfth aspect, in accordance with any one of the ninth to eleventh aspects, the first acquisition unit (21A) and the second acquisition unit (23A) have mutually different optical axes.

In the distance measurement imaging system (1A) of a thirteenth aspect, in accordance with any one of the ninth to twelfth aspects, the first acquisition unit (21A) and the second acquisition unit (23A) have mutually different spatial resolutions.

A distance measurement imaging method of a fourteenth aspect includes a first acquisition step, a second acquisition step, and a processing step. The first acquisition step includes acquiring first 2D data. The second acquisition step includes acquiring second 2D data and first 3D data with a coaxial optical system. The processing step includes executing a processing for making an association between the first 2D data and the second 2D data and a processing for making an association between the first 2D data and the first 3D data.

With this aspect, it is possible to obtain data associating 2D data (the first 2D data) and 3D data (the first 3D data) with each other.

A program of a fifteenth aspect is a program configured to cause one or more processors to execute the distance measurement imaging method of the fourteenth aspect.

With this aspect, it is possible to obtain data associating 2D data (the first 2D data) and 3D data (the first 3D data) with each other.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A distance measurement imaging system, comprising:
a first acquisition unit configured to acquire first 2D data from an imaging unit that acquires a first 2D image of a target space;
a second acquisition unit configured to acquire first 3D data from a distance measurement unit that acquires a first 3D image of the target space;
a third acquisition unit configured to acquire second 2D data and second 3D data from a detection unit that acquires a second 2D image and a second 3D image of the target space with a coaxial optical system; and
a computation unit configured to execute a processing for making an association between the first 2D data and the second 2D data and a processing for making an association between the first 3D data and the second 3D data.

2. The distance measurement imaging system of claim 1, wherein
the computation unit includes:
a 2D image conversion unit configured to perform conversion of assigning a pixel value of each of pixels of the first 2D image to an associated pixel region of the second 2D image to generate a calculated 2D image;
a 3D image conversion unit configured to perform conversion of assigning a pixel value of each of pixels of the first 3D image to an associated pixel region of the second 3D image to generate a calculated 3D image; and
an integration data generation unit configured to generate, based on the calculated 2D image and the calculated 3D image, integration data associating the first 2D data and the first 3D data with each other.

3. The distance measurement imaging system of claim 1, wherein
the detection unit is configured to:
divide the target space into a plurality of distance ranges based on a distance from the detection unit and generate a plurality of 2D images that corresponds respectively to the plurality of distance ranges;
generate the second 2D image by combining the plurality of 2D images together without identifying the distance ranges of the plurality of 2D images; and
generate the second 3D image by combining the plurality of 2D images together while identifying the distance ranges of the plurality of 2D images,
a plurality of pixels of the second 2D image and a plurality of pixels of the second 3D image correspond to each other in one-to-one relation.

4. The distance measurement imaging system of claim 1, wherein
the imaging unit and the detection unit have mutually different optical axes, and
the distance measurement unit and the detection unit have mutually different optical axes.

5. The distance measurement imaging system of claim 1, wherein
the imaging unit and the detection unit have mutually different spatial resolutions, and
the distance measurement unit and the detection unit have mutually different distance resolutions.

6. The distance measurement imaging system of claim 1, further comprising at least one of the imaging unit, the distance measurement unit, or the detection unit.

7. A distance measurement imaging method, comprising:
a first acquisition step of acquiring first 2D data from an imaging unit that acquires a first 2D image of a target space;
a second acquisition step of acquiring first 3D data from a distance measurement unit that acquires a first 3D image of the target space;
a third acquisition step of acquiring second 2D data and second 3D data from a detection unit that acquires a second 2D image and a second 3D image of the target space with a coaxial optical system; and
a processing step of executing a processing for making an association between the first 2D data and the second 2D data and a processing for making an association between the first 3D data and the second 3D data.

8. A non-transitory computer readable storage medium storing a program configured to cause one or more processors to execute the distance measurement imaging method of claim 7.

9. A distance measurement imaging system, comprising:
a first acquisition unit configured to acquire first 2D data;
a second acquisition unit configured to acquire second 2D data and first 3D data with a coaxial optical system; and
a computation unit configured to execute a processing for making an association between the first 2D data and the second 2D data and a processing for making an association between the first 2D data and the first 3D data.

10. The distance measurement imaging system of claim 9, wherein
the computation unit includes:
a 2D data conversion unit configured to execute a processing for making an association between the first 2D data and the second 2D data with each other by performing conversion of assigning a pixel value of each of pixels of the first 2D data to an associated pixel region of the second 2D data to generate a calculated 2D data; and
an integration data generation unit configured to generate, based on the calculated 2D data and the first 3D data, integration data associating the first 2D data and the first 3D data with each other.

11. The distance measurement imaging system of claim 9, wherein
a plurality of pixels of the second 2D data and a plurality of pixels of the first 3D data correspond to each other in one-to-one relation.

12. The distance measurement imaging system of claim 9, wherein
the first acquisition unit and the second acquisition unit have mutually different optical axes.

13. The distance measurement imaging system of claim 9, wherein
the first acquisition unit and the second acquisition unit have mutually different spatial resolutions.

14. A distance measurement imaging method, comprising:
a first acquisition step of acquiring first 2D data;
a second acquisition step of acquiring second 2D data and first 3D data with a coaxial optical system; and
a processing step of executing a processing for making an association between the first 2D data and the second 2D data and a processing for making an association between the first 2D data and the first 3D data.

15. A non-transitory computer readable storage medium that stores a program configured to cause one or more processors to execute the distance measurement imaging method of claim 14.
